(19) United States
(12) Patent Application Publication
(10) Pub. No.: US 2003/0110154 A1
(43) Pub. Date: Jun. 12, 2003

(54) Multi-processor, content-based traffic management system and a content-based traffic management system for handling both HTTP and non-HTTP data

(76) Inventors: Mark M. Ishihara, San Diego, CA (US); Steve S. Schnetzler, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/013,950

(22) Filed: Dec. 7, 2001

(51) Int. Cl. G06F 7/00

(52) U.S. Cl. 707/1

(57) ABSTRACT

The improved multi-processor data traffic management system comprises a connection brokering interface coupled to load balancing applications and connection brokering extension applications, which permit load balancing functions to be performed, concurrently if desired, on multiple processors, thereby improving the performance and speed of the system. Also described, an improved data traffic management system does content-based processing of both HTTP and non-HTTP data. This improved HTTP/non-HTTP system accesses discrete entities of data based on one of two event conditions: a minimum amount of non-HTTP data has been received or a maximum wait time for receiving non-HTTP data has been exceeded, both of which may be dynamically changed. By handing off data from a load balancing application to a translation application in controlled quantities, the translation application is allowed to analyze the data and designate its own endpoints or transition points for incoming client request data and outgoing server response data.

### FIELD OF THE INVENTION

This invention relates to content-based electronic data traffic management systems, and more particularly to a content-based data traffic management system for a multi-processor environment and a content-based data traffic management system which handles both HTTP and non-HTTP data streams.

### BACKGROUND

In a network over which various and numerous data streams are communicated, such as the internet, client computers or devices (hereinafter, referred to as “client” or “clients”) may issue data requests or other requests which create an overburden on a portion of the network. For example, internet users may overburden a server with requests of a popular website. As a result, load balancers and other traffic management applications have been used to forward client requests to servers in a manner which reduces overall response time to process a request. The prior art approaches accommodate URL (Uniform Resource Locator) by performing basic pattern matching on data in HTTP request headers and error detection on HTTP response headers. These prior art approaches were designed to run in a single process on a single processor. For example, F5 has a BIG-IP Load Balancer product that manages traffic by using scripts to define traffic patterns and load balancing functions. With the increasing use of data communication and the internet, there is a need to improve the management of network traffic.

HTTP protocol is a well known communication protocol for transferring data over, for example, the internet. Each message sent according to the HTTP protocol contains a HTTP header and the body. The number of bytes of the data stream is specified in the HTTP header of the HTTP data so that the engines which process HTTP data knows exactly when the data stream starts and ends. However, some people transfer data and information based on non-HTTP protocols such as SMTP (Simple Mail Transfer Protocol), SNMP (Simple Network Transfer Protocol), FTP (File Transfer Protocol) and telnet (which permits a remote login to a server), or their own user-defined protocols. The prior art engines that process HTTP data streams are not able to make content-based decisions such as server selection and error detection based on non-HTTP data streams. The main reason for this is that the prior art engines cannot detect the endpoint for a request or response entity. If there is no distinction of a complete request or response entity, a content-based engine cannot determine at which point a request can be sent to a fulfillment server or a response can be returned to a client. Therefore, there is a need for a load balancer system capable of making content-based decisions for both HTTP and non-HTTP data streams.

### BRIEF DESCRIPTION OF THE DRAWINGS

The components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 is a representation of a high level block diagram of an improved multi-processor data traffic management system.

FIG. 2 is a representation of the major data elements of the improved multi-processor data traffic management system of FIG. 1.

FIG. 3 is a representation of an example control flow for a connection brokering function performed by the improved multi-processor data traffic management system of FIG. 1.

FIG. 4 is a representation of an example data flow for a connection brokering function performed by the improved multi-processor data traffic management system of FIG. 1.

FIG. 5 is a representation of a high level block diagram of an improved data traffic management system which handles non-HTTP protocols.

FIG. 6 is an example flowchart of a Translation Application's processing of incoming client data in the improved data traffic management system which handles non-HTTP protocols of FIG. 5.

### DETAILED DESCRIPTION OF THE PREFERRED EMBODIMENTS

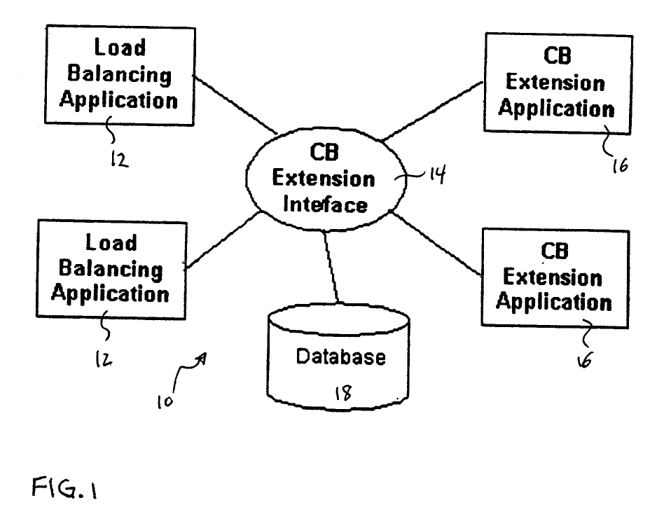

FIG. 1 is a representation of a high level block diagram of an improved multi-processor content-based traffic management system 10. In the first example embodiment illustrated in FIG. 1, one or more load balancing applications 12 is coupled to a connection brokering interface 14 which in turn is coupled to a database 18 and one or more connection brokering extension applications 16. Preferably, there are multiple load balancing applications 12 and multiple connection brokering extension applications 16. The connection brokering extension applications 16 perform connection brokering functions as will be explained. In an example embodiment, the connection brokering interface 14 may comprise a C-library extension interface written in C, a popular software language. The database 18 is a shared database. The connection brokering interface 14 exposes a set of Application Programmer's Interfaces (API's) which allow users to make or use algorithms to analyze incoming data streams and communicate decisions back to the load balancing applications. In general, API's are software utility functions that programs can call to get work done. Specifically, in the case of extension applications, connection brokering API's could be used to access request data, and for example, help determine whether the user making the request is a frequent customer, a valued customer (e.g., the user has a high account balance, say greater than $50,000), or a special type of customer requiring preferential treatment. Based on the analysis of the incoming data, the traffic management system 10 may decide to route the user's request to a faster server. Thus, the traffic management system 10 is “content-based” and the load balancing applications 12 may perform standard HTTP proxying, Secure Socket Layer (“SSL”) decryption and encryption and/or any load balancing functions. Preferably the content-based traffic management system 10 manages traffic on a load balancer for enhanced layer 7, an application layer described in International Standard Organization's Open System Interconnect (ISO/OSI) network protocol. The ISO/OSI protocol layers are further explained at http://uwsg.iu.edu/usail/network/nfs/ network_layers.html.

FIG. 2 is a representation of the major data elements of the improved multi-processor data traffic management system of FIG. 1. Each of the load balancing applications 12 and each of the connection brokering extension applications 16 may have an input queue 28 and an application block 30. The input queue 28 holds incoming events such as requests, tasks and actions. An application block 30 identifies its load balancing application 12 or connection brokering application 16 and contains data specific to the application. In an example embodiment, the data in an application block 30 includes the name of the application, process identification information (pid) and status. Control blocks 32 dictate conditions under which a load balancing application 12 may send a task, also referred to as an event, to a connection brokering extension application 16. Control blocks 32 also identify which connection brokering extension application 16 is deemed the destination application for receiving the task. Thus, based on the identification provided by a control block 32, a load balancing application 12 knows to which connection brokering extension application 16 to send a task. Control blocks 32 are created and maintained by connection brokering extension applications 16 and are assigned on a per service basis. A service is a virtual resource that the load balancer provides to network clients. Services may be identified by the Virtual Internet Protocol (VIP) address and virtual port number. Client requests for a server are received over the network (e.g., the internet) by a load balancer and directed to the most appropriate server based on the load balancing algorithm assigned for that service. A data block 34 stores data specific to each connection established between a load balancing application 12 and a connection brokering extension application 16. Data blocks 34 are created by the load balancing applications 12 and are updated by both load balancing applications 12 and connection brokering extension applications 16. The control blocks 32 and the data blocks are stored on the shared database 18. The improved multi-processor data traffic management system 10 has configuration and persistence data 36, which include set up parameters, definition of services and servers, initialization data and system configuration information. Configuration and persistence data 36 is saved and restored to and/or from a file on the shared database 18.

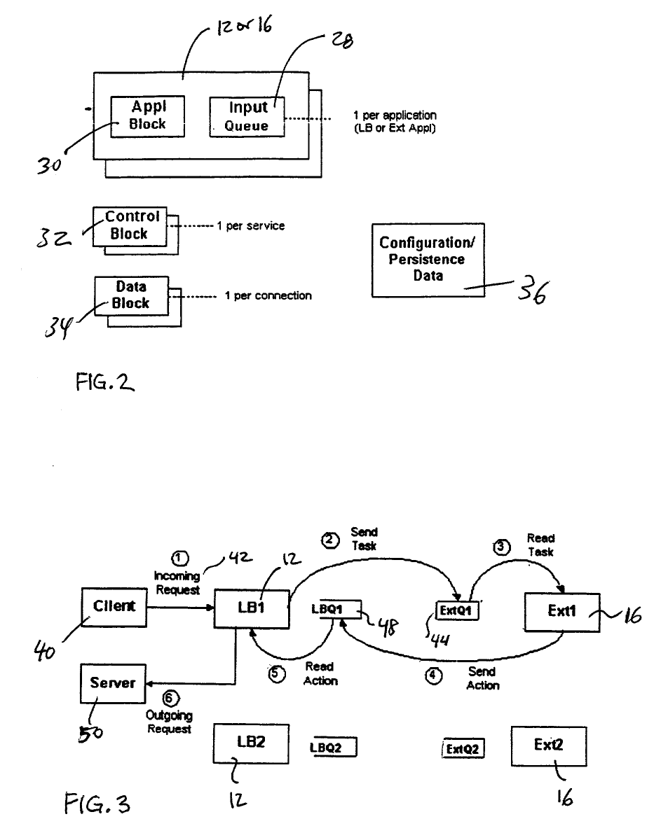

FIG. 3 is a representation of an example control flow for a connection brokering function performed by the improved multi-processor data traffic management system of FIG. 1. Referring to FIG. 3, an example protocol is shown for the flow of control in the improved multi-processor data traffic management system. First, a client 40 issues a request 42 for a service to a load balancing application 12, also denoted LB1. Based on the request 42 and whether the event conditions specified in a control block 32 are satisfied, the load balancing application 12 populates a data block 34 for a connection to a connection brokering extension application 16, also denoted Ext1, and sends a task to the input queue 44 of the connection brokering extension application 16 (Ext1). The connection brokering extension application 16 (Ext1) reads the task from its input queue 44, accesses the data sent from the client 40 in the data block 34, makes a decision (e.g., executes its task and makes a determination), and potentially modifies the data in the data block 34. For example, each of the connection brokering extension applications 16 could perform a task such as an ordinary virus scan, an extraordinary virus scan, error detection, server selection, connection abortion, etc. After executing its task, the connection brokering extension application 16 (Ext1) sends an action, which includes its decision, to the input queue 48 of the load balancing application 12 (LB1). The load balancing application 12 (LB1) reads the action from its queue 48 and processes the action. In the example where the action is to route the client's request 42 to the appropriate server 50 for processing, the load balancing application 12 (LB1) will do so.

FIG. 3 also illustrates other load balancing applications 12 (e.g., see LB2) and other connection brokering extension applications 16 (e.g., see Ext2). The reason is that, in another example, the client 40 could have sent a request 42 for a service which is handled by LB2 instead of LB1 and/or the load balancing application 12 could have sent the task to Ext2 instead of Ext1. Further, as LB1 is permitted to send a task to Ext1 and another task to Ext2, parallel processing of tasks may occur, thereby increasing the performance of the traffic management system. Of course, LB2 is also permitted to send a task to Ext1 and another task to Ext2. Still further, if the network traffic is large, both LB1 and LB2 may be used so that parallel or multi-processing of requests may be handled more quickly and efficiently. Thus, various parallel processing (or multiple processing scenarios) are possible. In the alternative, LB2 may serve as a redundant load balancing application for LB1, where LB2 can take over should LB1 fail. Moreover, each of the load balancing applications 12 can run on a different processor and thus, the load balancing applications 12 may run in a multi-processor environment. Of course, the multiple processors can be running on a single computer/server or on multiple computers or servers. Likewise, each of the connection brokering extension applications 16 can run on a different processor and thus, may run in a multi-processor environment.

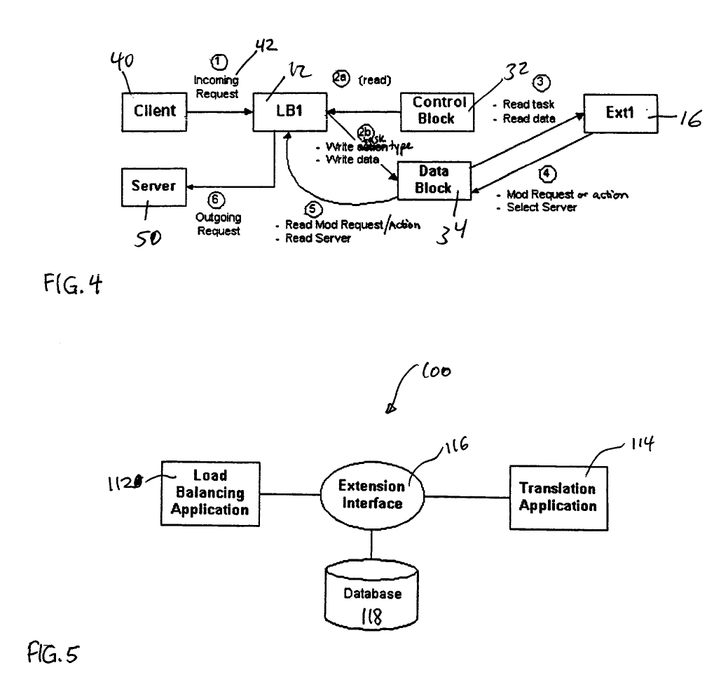

FIG. 4 is a representation of an example data flow for a connection brokering function performed by the improved multi-processor data traffic management system of FIG. 1. FIGS. 3 and 4 work together in conjunction during normal operation. That is, FIG. 3 describes the control flow while FIG. 4 describes the data flow. Similar control and data flows exist for processing responses from servers by load balancing applications 12 and connection brokering extension applications 16 and for routing responses back to the client 40. The data flow is similar to the control flow discussed in FIG. 3, except that the data flow processes control and data blocks 32, 34 instead of event queues 44, 48.

A client 40 issues a request 42 for a service to a load balancing application 12 (LB1). After receiving the request 42, the load balancing application 12 (LB1) reads the control block 32 to determine whether the event conditions specified in the control block 32 are satisfied. If the event conditions have been satisfied, the load balancing application 12 (LB1) writes a task to the input queue 44 of the connection brokering extension application 16 (Ext1), as shown in FIG. 3, and writes a task type and data to the data block 34. The task type indicates what type of task is being sent to the connection brokering extension application 16 (Ext1). For example, the task type can signify that a request has arrived, a response has arrived, etc. The data block 34 specifies data for a connection from the load balancing application 12 (LB1) to a connection brokering extension application 16 (Ext1). The connection brokering extension application 16 (Ext1) reads the task from its input queue 44 as shown in FIG. 3, accesses the data in the data block 34 as shown in FIG. 4, makes a decision (e.g., select a server), and potentially modifies the data in the data block 34. For example, each of the connection brokering extension applications 16 could perform a task such as an ordinary virus scan, an extraordinary virus scan, error detection, server selection, connection abortion, etc. After executing its task, the connection brokering extension application 16 (Ext1) sends an action to the input queue 48 of the load balancing application 12 (LB1) and updates the data block 34 with the decision which goes along with the action. The load balancing application 12 (LB1) reads the action from its input queue 48 and reads the decision (e.g., server selection) and potentially modified request data from the data block 34 and processes the action. In the example where the action is to route the client's request 42 to the appropriate server 50 for processing, the load balancing application 12 (LB1) will do so.

Hence, by maintaining individual event queues 44, 48 for each load balancing application 12 and each connection brokering extension application 16 and by identifying each connection between a load balancing application 12 and a connection brokering extension application 16 in a control block 32 and a data block 34, multiple processors are allowed to work together to set up and process connections and to make load balancing decisions.

Therefore, the improved content-based multi-processor traffic management system 10 differs from the prior art single processor approaches. By being run in a multi-process, multi-processor environment, the distributed nature of traffic management functions in the improved multi-processor traffic management system allows multiple load balancing applications 12 to run concurrently. Further, the improved multi-processor traffic management system permits each load balancing application 12 to interface and cooperate with multiple extension applications, each of which may perform specialized tasking or functions. As a result, the improved multi-processor traffic management system provides connection brokering in a distributed and parallel processing environment, thereby improving the efficiency and performance of data traffic management. Higher connections per second and simultaneous connections may be achieved. Other advantages which may result include allowing the data traffic management system to access all portions of message data (e.g., not just the headers), modify incoming data from a client, modify outgoing data to a server, replay the client's data on an alternate server, and abort a client or server connection and return a canned response or error message. The reliability and robustness of the improved traffic management system 10 are improved because if a load balancing application 12 or a connection brokering extension application 16 were to fail, only those connections for services tied to the failed application would be affected. With redundancy in load balancing or connection brokering extension applications, reliability and robustness of the system are better. Also, by spreading functionality across multiple connection brokering extension applications 16, the complexity of each connection brokering extension application 16 is simplified. As a result, each connection brokering extension application 16 can be developed and verified in a shorter time.

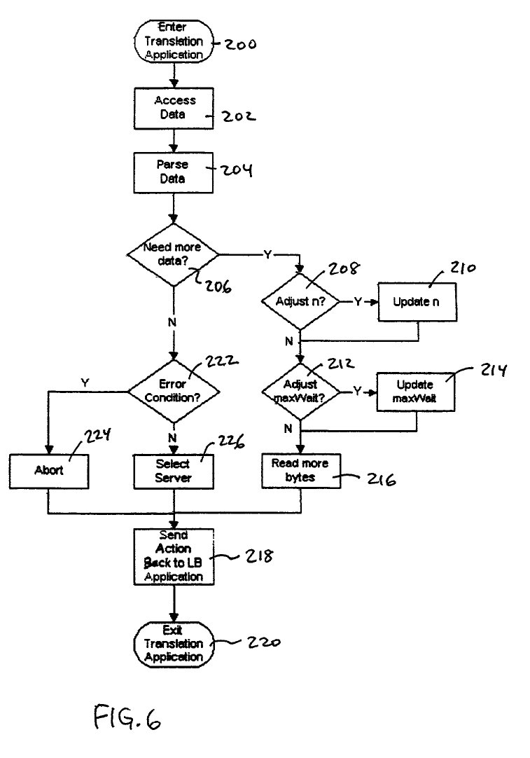

FIG. 5 is a representation of a high level block diagram of an improved data traffic management system 100 which handles both HTTP and non-HTTP protocols. The improved HTTP/non-HTTP data traffic management system 100 comprises a load balancing application 112, which can be the load balancing application 12 previously described, a translation application 114, an extension interface 116 and a shared database 118. The extension interface 116 acts as the interface between the load balancing application 112, the translation application 114 and the shared database 118. The shared database 118 may be the shared database 18 previously described. The load balancing application 112 may perform standard HTTP proxying, SSL decryption and/or encryption and load balancing functions. The extension interface 116 communicates data and events between the load balancing application 112 and the translation application 114 via API calls and the shared database 118. Preferably, the translation application 114 accesses data and events, performs non-HTTP content-based analyses, potentially modifies the data, and communicates decisions to the load balancing application 112. The non-HTTP content-based analyses may include, but are not limited to, error detection and selecting a server for the load balancing application 112.

The load balancing application 112 and the translation application 114 follow a protocol which dictates whether an event (e.g., a client request) is triggered based on whether any one of two conditions has been satisfied. The two conditions are set by the translation application 114. In this example embodiment, the two conditions are (1) when a minimum amount of data has been received (e.g., the minimum data size condition, preferably in bytes) or (2) when a maximum period of time for receiving non-HTTP data has been exceeded (e.g., the maximum wait period, preferably in milliseconds). When a load balancing application 112 receives non-HTTP data fi-om a client request for a service, the load balancing application 112 buffers the data internally until triggered by the occurrence of one of the two conditions. In this example embodiment, the load balancing application 112 buffers discrete entities of the data at a time until one of the two conditions is satisfied. Because non-HTTP data lack well-defined endpoints to determine complete requests or responses and are not required to contain headers that delineate the exact size of a request or response, the two event condition capabilities allow a translation application to access data in discrete entities controlled by the translation application. Thus, the translation application can examine the data and decide what constitutes a request that can be sent to a fulfillment server or a response that can be returned to a client. As a side benefit of setting a minimum data size and maximum wait period, the improved HTTP/non-HTTP data traffic management system 100 can be assured that it has enough hardware resources such as buffer memory to store the non-HTTP data.

When triggered, the load balancing application 112 sends the event (e.g., a client request) to the extension interface 116 which sends the event to the translation application 114. The translation application 114 performs content-based processing of the data by accessing the data in the shared database 118, parsing it and determining if more data 20 is required for the translation application 114 to make a decision. If additional data is not required, the translation application 114 makes a decision, such as whether to abort the client request or select a server to which to route the client's request. The decision of the translation application 114 is written to the shared database 18 and the translation application 114 sends an action request to the load balancing application 112. The load balancing application 112 follows the action and sends the client's request to the appropriate server and may wait for an acknowledging response or confirmation from the server. If the response from the server indicates there was an error in processing the client's request, the load balancing application 112 may, for example, send an error message to the client or re-send the client's request to a different server. In an embodiment where the load balancing application 112 and the translation application 114 are on separate processors, they can work concurrently, thereby improving the performance of the system. If the load balancing application 112 and the translation application 114 are on different processors, the processors can be located on the same or different devices. In both cases, the applications 112, 114 communicate through the extension interface 116.

FIG. 6 is an example flowchart of the processing by a translation application 114 of incoming client data in the improved data traffic management system which handles non-HTTP data of FIG. 5. Upon entering the translation application at step 200, the translation application 114 accesses the data in step 202 and parses the data in step 204. The translation application 114 determines whether more data is required for it to make a decision (e.g., abort the client requested activity, select a server to handle the client's request), as shown in step 206. If more data is required, the translation application 114 determines whether to adjust the minimum data size to account for the additional data required (step 208). If the requirement for additional data makes it necessary to increase the minimum data size condition, the translation application 114 updates the minimum data size in the shared database 118, as shown in step 210. The two conditions, if changed, affect when the next event is deemed to have been triggered. As a result, adaptive and flexible event triggering can be implemented between the load balancing application and the translation application. After determining whether to adjust the minimum data size, step 212 determines whether to adjust the maximum wait time condition, also to account for the additional data required. If the maximum wait time needs to be adjusted, it is adjusted in step 214. Otherwise, the translation application 114 goes ahead and reads the additional data (step 216). Thereafter, the translation application 114 sends an action back to the load balancing application 112, as shown in step 218, and the translation application 114 finishes its processing, as shown in step 220. If, on the other hand, additional data is not required in step 206, the translation application 114 determines whether there is an error condition (step 222) which can cause the translation application 114 to abort the process if necessary (step 224). If there is no error condition, the translation application 114 sends an action to the load balancing application 112, as shown in step 218, and the translation application 114 finishes its processing, as shown in step 220.

This process for handling incoming client's requests can be applied for outgoing server responses too. For example, the load balancing application 112 can pass fixed or variable sized blocks of server response data to the translation application 114. The translation application 114 may then analyze the server response data and make a decision based on the analysis. For example, the translation application 114 may perform error detection or other processing of the server response data. Another example is to replay the original client's request to a different server. The translation application 114 writes an action back to the load balancing application 112 which indicates whether the load balancing application 112 should route the server response data to the client, retrieve additional server response data from the server, or abort the current client or server activity.

The improved HTTP/non-HTTP data traffic management system may be used with different load balancing applications and can handle various kinds of non-HTTP protocols. For example, if SMTP is used, the improved system is able to filter emails or to parse emails in order to make decisions about what to do with the email. If SMTP, SNMP, ftp, telnet, or any other non-HTTP protocol is used, the improved system permits analyses to be performed on the data and these analyses may form the basis for decisions. Advantageously, many types of decisions are possible. For instance, if a user sends a request to download a file from a server, which file is also resident on other servers, the improved system can select the fastest server from which to download the file. The improved system can analyze the request to determine which server should receive the user's request. Another option is to “replay” the user's request because the request is kept in memory until the improved system receives a confirmation from a server that the server processed the user's request successfully. If the improved system were to receive an error message or fail to receive confirmation that the server received the request successfully, the improved system can forward the request to a different server, thereby improving reliability.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, and the invention can be performed using different or additional process actions, or a different combination or ordering of process actions. As another example, each feature of one embodiment can be mixed and matched with other features shown in other embodiments. Features and processes known to those of ordinary skill in the art of networking may similarly be incorporated as desired. Additionally and obviously, features may be added or subtracted as desired. Accordingly, the invention is not to be restricted except in light of the attached claims and their equivalents.

We claim:

1. A content-based data management system comprising:
a load balancing application to receive a request from a client;
an interface coupled to the load balancing application;
an extension application coupled to the interface, the extension application to receive a task from the load balancing application, to analyze the task and to send an action to the load balancing application, the extension application and the load balancing application capable of performing at least partially concurrently; and
a database coupled to the interface, the database being accessible to the load balancing application and the extension application.

2. The system of claim 1 wherein the load balancing application is to be executed by a first processor and the extension application is to be executed by a second processor.

3. The system of claim 1 further comprising a first queue, the first queue to receive the task from the load balancing application, the extension application coupled to the first queue to receive the task from the first queue.

4. The system of claim 1 further comprising a second queue, the second queue to receive the action from the extension application, the load balancing application coupled to the second queue to receive the action from the extension application.

5. The system of claim 1 wherein in response to the action from the extension application, the load balancing application to send the request from the client to a selected server.

6. The system of claim 1 further comprising a plurality of load balancing applications, each load balancing application to receive a request from a client, and a plurality of extension applications, each extension application to receive a task.

7. The system of claim 1 further comprising a data structure, the load balancing application to write a task into the data structure and the extension application to read the task from the data structure and to write a decision into the data structure, the load balancing application to read the decision from the data structure.

8. The system of claim 4 further comprising a data structure, the load balancing application to write a task into the data structure and the extension application to read the task from the data structure and to write a decision into the data structure, the load balancing application to read the decision from the data structure.

9. The system of claim 1 wherein after the extension application analyzes the task, the extension application to select a server to which the load balancing application is to send the request.

10. A content-based method of managing a data request from a client, comprising:
providing a load balancing application, an extension application and an interface coupled to the load balancing application and the extension application;
sending a request to the load balancing application;
sending a task to the extension application from the load balancing application through the interface;
analyzing the task;
sending a decision to the load balancing application from the extension application; and
reading the decision.

11. The method of claim 10 wherein the decision instructs the load balancing application to which server to send the request.

12. The method of claim 10 wherein task is generated by a first processor and the decision is generated by a second processor.

13. The method of claim 10 further comprising queuing the task from the load balancing application for the extension application to receive.

14. The method of claim 10 further comprising queuing an action from the extension application for the load balancing application to receive.

15. The method of claim 13 further comprising queuing an action from the extension application for the load balancing application to receive.

16. A content-based data management system to handle both HTTP and non-HTTP data, the system comprising:
a load balancing application to receive HTTP data and non-HTTP data from a client or server;
an interface coupled to the load balancing application;
a translation application coupled to the interface,
a condition set by the translation application, the load balancing application to receive and to store the non-HTTP data until the load balancing application determines that the condition is satisfied, the load balancing application to send an event to the translation application after the condition is satisfied;
after receiving the event, the translation application to analyze the non-HTTP data, make a decision and send the decision to the load balancing application.

17. The system of claim 16, wherein the translation application determines whether to modify the condition before the translation application sends the decision to the load balancing application.

18. The system of claim 16, wherein the condition is satisfied when the amount of non-HTTP data received by the load balancing application exceeds a minimum amount.

19. The system of claim 16, wherein the condition is satisfied when the time expended in receiving non-HTTP data by the load balancing application exceeds a maximum wait time.

20. The system of claim 16, wherein the condition is satisfied when the amount of non-HTTP data received by the load balancing application exceeds a minimum amount or when the time expended in receiving non-HTTP data by the load balancing application exceeds a maximum wait time.

21. The system of claim 17, wherein if the translation application determines that it would like to receive more non-HTTP data before making the decision to the load balancing application, the translation application modifies the condition.

22. A content-based method of handling both HTTP and non-HTTP data, the method comprising:
providing a load balancing application, a translation application and an interface coupled to the load balancing application and the translation application;
setting a condition for non-HTTP data;
receiving non-HTTP data from a client or server by the load balancing application;
storing the non-HTTP data until the load balancing application determines that the condition is satisfied; and
after the condition has been satisfied, allowing the translation application to analyze the non-HTTP data, make a decision and send the decision to the load balancing application.

23. The method of claim 22, wherein the translation application determines whether to modify the condition.

24. The method of claim 22, wherein the condition is satisfied when the amount of non-HTTP data received by the load balancing application exceeds a minimum amount.

25. The method of claim 22, wherein the condition is satisfied when the time expended in receiving non-HTTP data by the load balancing application exceeds a maximum wait time.

26. The method of claim 22, wherein the condition is satisfied when the amount of non-HTTP data received by the load balancing application exceeds a minimum amount or when the time expended in receiving non-HTTP data by the load balancing application exceeds a maximum wait time.

27. A computer-usable medium comprising a sequence of instructions which, when executed by a processor, causes the processor to perform a method of receiving and processing non-HTTP data, comprising:
setting a condition to determine the end of a non-HTTP data stream;
receiving at least a portion of the non-HTTP data stream from a client or server;
storing each portion of the non-HTTP data stream until the condition is satisfied; and
after the condition has been satisfied, analyzing the non-HTTP data stream and making a decision based on the content of the non-HTTP data stream.

28. The computer-usable medium of claim 27, wherein the condition is satisfied when the amount of the non-HTTP data stream received exceeds a minimum amount.

29. The computer-usable medium of claim 27, wherein the condition is satisfied when the time expended in receiving the non-HTTP data stream exceeds a maximum wait time.

30. The computer-usable medium of claim 27, wherein the condition is satisfied when the amount of the non-HTTP data stream received exceeds a minimum amount or when the time expended in receiving the non-HTTP data stream exceeds a maximum wait time.
